(19) United States
(12) Patent Application Publication
(10) Pub. No.: US 2001/0041993 A1
(43) Pub. Date: Nov. 15, 2001

(54) Automated claim processing and attorney referral and selection

(76) Inventor: Richard L. Campbell, Hopkinton, NH (US)

Correspondence Address: TESTA, HURWITZ & THIBEAULT, LLP, HIGH STREET TOWER, 125 HIGH STREET, BOSTON, MA, 02110, US

(21) Appl. No.: 09/776,016

(22) Filed: Feb. 2, 2001

Related U.S. Application Data
(60) Provisional application No. 60/179,921, filed on Feb. 3, 2000.

(51) Int. Cl. G06F 17/60

(52) U.S. Cl. 705/4

(57) ABSTRACT

A computer-based method and system for managing insurance claims enables a claimant (with or without an attorney) and an insurance carrier to initiate, document, value, and negotiate an insurance claim in a timely manner while minimizing expense associated therewith. The claimant accesses the system over a network and is guided systematically from claim initiation to claim resolution. The claimant is provided with information on the credibility of the insurance claim and easy to use tools to help determine the value of the insurance claim. Additionally, the claimant is provided with an option to “auction” the insurance claim to an attorney in the event negotiations between the claimant and the insurance carrier do not lead to a settlement.

### CROSS REFERENCE TO RELATED CASES

This claims priority to and the benefit of Provisional U.S. Patent Application Ser. No. 60/179,921, filed Feb. 3, 2000, and Provisional U.S. Patent Application Ser. No. 60/192,868, filed Mar. 29, 2000, and the entirety of both applications is incorporated herein by reference.

### TECHNICAL FIELD

The invention relates generally to insurance claim processing and more particularly to a computer-based method and system for managing insurance claims and referring unresolved insurance claims to attorneys.

### BACKGROUND INFORMATION

Many millions of automobiles are registered for use in the United Sates. Annually, several million automobile accidents are reported to police departments across the country. These accidents produce many deaths and personal injuries, and much property damage. Compensation for the losses from insurance claims arising from the accidents has totaled many billions of dollars for personal injuries alone.

Each year, insurance carriers pay billions of dollars in legal fees and overhead to resolve personal injury claims resulting from auto accidents. Claimants generally pay their lawyers between thirty and fifty percent of their insurance settlement amount or jury award, and usually must wait well over a year to receive compensation for their damages. Additionally, billions of dollars are spent on medical expenses, and part of this amount might possibly be due to the current insurance system's minimums that are imposed before a claim will considered.

### SUMMARY OF THE INVENTION

The current manner and means of presenting, investigating, evaluating, and resolving claims are factors resulting the current high annual expenditures associated with such presentment, investigation, evaluation, and resolution. These expenditures can be dramatically reduced according to the invention by one or more of the following: introducing Internet-based efficiencies, educating claimants with respect to claim credibility and claim valuation, and providing open pricing for legal services.

The invention generally relates to a computer-based method and system for managing insurance claims. A claimant (alone or with an attorney) and an insurance carrier can initiate, document, value, and negotiate the resolution of an insurance claim in a timely manner while minimizing the expense(s) associated therewith and while also generally minimizing the involvement of lawyers. The invention provides the claimant with information on the credibility of the insurance claim and easy to use tools to help determine the value of the insurance claim. Knowledge of the claims credibility and value allows the claimant to negotiate directly and more effectively with the insurance carrier(s). Additionally, the claimant is provided with an option to “auction” the insurance claim to an attorney for legal assistance in the event negotiations between the claimant and the insurance carrier do not lead to a settlement. The present invention also allows insurance carriers to review claims data instantly and at a reduced cost and improved efficiency when compared to present methods and systems. If a claimant has retained an attorney, the claimant's attorney can use the system to document, value, and negotiate with an insurance carrier on his client's behalf. The system empowers the claimant's attorney to resolve a claim much faster than under the current system, thereby allowing the attorney to collect legal fees much more quickly. By resolving claims faster, attorneys can handle more cases and generate more income and better server their clients, the claimants.

The invention can be used to handle any of a variety of insurance claims including personal injury claims, medical malpractice claims, workers compensation claims, asbestos claims, warranty claims, and property damage (auto, home, etc.) claims, for example. The invention can also be used to handle liability claims that arise out of accidents that occur on the premises of a corporation, or accidents involving the corporation's vehicles.

One aspect of the present invention involves a computer-based method of managing an insurance claim. The method comprises sending over a network to a claimant a questionnaire about an incident, receiving over the network a response to the questionnaire, and sending over the network to the claimant a request for at least one document associated with the incident. The request is based on at least some of the received response to the questionnaire. The method further comprises receiving, storing, and maintaining the at least one document requested of the claimant and creating the insurance claim which includes the at least one document and the at least some of the response to the questionnaire. The method still further comprises assigning a credibility rating to the insurance claim based on the at least one document and at least some of the response to the questionnaire.

In some embodiments, the method further comprises estimating a monetary value associated with the insurance claim. In some other embodiments, the method further comprises submitting the insurance claim to an insurance company on behalf of the claimant. In still other embodiments, the method further comprises negotiating terms of a claim settlement with the insurance company. In some other embodiments, the method further comprises requesting an attorney to represent the claimant.

In still other embodiments, the method further comprises generating an abstract of the insurance claim. In other embodiments, the method further comprises editing the at least one document sent in response to receiving a request based on at least some of the received response to the questionnaire. In other embodiments, the method further comprises electronically generating and storing notes associated with the insurance claim. In still other embodiments, the network comprises the Internet.

Another aspect of the invention involves a computer-based system for managing an insurance claim. The system comprises an electronic questionnaire module, a receiving module, a document request module, a receiving, storage, and maintenance module, an insurance claim creation module, and an insurance claim credibility assessment module. The electronic questionnaire module sends over a network to a claimant a questionnaire about an incident. The receiving module receives over the network a response to the questionnaire. The document request module sends over the network to the claimant a request for at least one document associated with the incident. The request is based on at least some of the received response to the questionnaire. The receiving, storage, and maintenance module receives, stores, and maintains the at least one document requested of the claimant. The insurance claim creation module creates the insurance claim which includes the at least one document and the at least some of the response to the questionnaire. The insurance claim credibility assessment module assigns a credibility rating to the insurance claim based on the at least one document and at least some of the response to the questionnaire.

In one embodiment, the system further comprises an insurance claim valuation module for estimating a monetary value associated with the insurance claim. In other embodiments, the system further comprises an insurance claim submission module for submitting the insurance claim to an insurance company on behalf of the claimant. In other embodiments, the system further comprises an insurance claim negotiation module for negotiating terms of a claim settlement with the insurance company. In still other embodiments, the system further comprises an attorney request module for requesting an attorney. In other embodiments, the system further comprises a claim abstract module for generating an abstract of the at least one insurance claim.

In still other embodiments, the system further comprises an editing module for editing the at least one document sent in response to receiving a request based on at least some of the received response to the questionnaire. In other embodiments, the system further comprises a note module for electronically generating and storing notes associated with the insurance claim. In still other embodiments, the network comprises the Internet.

Still another aspect of the invention is a method of evaluating the credibility of an insurance claim. The method comprises sending over a network to a claimant a questionnaire about an incident, receiving over the network a response to the questionnaire, and sending over the network to the claimant a request for at least one document associated the incident. The request is based on at least some of the received response to the questionnaire. The method further comprises determining a credibility score based on the at least one document and the at least some of the received response to the questionnaire.

In one embodiment, the method further comprises reporting over the network to the claimant the credibility score and how the credibility score was calculated. The claimant is informed, over the network, about any documents not yet received that affect the calculation of the credibility score.

These and other aspects, features, and advantages of the invention will become more apparent from the following drawings and description.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic illustration of an embodiment of a system according to the invention.

FIG. 2 is an illustrative block diagram of the claims processing software components associated with the system in FIG. 1.

FIG. 3 is an illustrative block diagram of the auction software components associated with the system in FIG. 1.

FIGS. 4A and 4B are flow diagrams illustrating the steps a claimant follows to initiate and submit a claim according to one embodiment of the invention.

FIGS. 5A and 5B are flow diagrams illustrating the steps an insurance carrier follows to process a claim filed by a claimant according to one embodiment of the invention.

FIGS. 6A and 6B are flow diagrams illustrating the steps for negotiating a settlement to a claim according to one embodiment of the invention.

FIGS. 7A and 7B are flow diagrams illustrating the steps for auctioning an unresolved insurance claim to an attorney according to one embodiment of the invention.

### DESCRIPTION

The invention generally relates to a computer-based method and system for managing insurance claims. According to one embodiment of the invention, a claimant (alone or with an attorney) and an insurance carrier can initiate, document, value, and negotiate the resolution of an insurance claim in a timely manner while minimizing the expense(s) associated therewith and while also generally minimizing the involvement of lawyers. The claimant accesses the system via a communication network and is guided systematically from claim initiation to claim resolution. In one embodiment, the invention provides the claimant with information on the credibility of the insurance claim and easy to use tools to help determine the value of the insurance claim. Knowledge of the claims credibility and value allows the claimant to negotiate directly and more effectively with the insurance carrier(s). Additionally, the claimant is provided with an option to “auction” the insurance claim to an attorney for legal assistance in the event negotiations between the claimant and the insurance carrier do not lead to a settlement. The present invention also allows insurance carriers to review claims data instantly and at a reduced cost and improved efficiency when compared to present methods and systems.

If a claimant has retained an attorney, the claimant's attorney can use the system to document, value, and negotiate with an insurance carrier on his client's behalf. The system empowers the claimant's attorney to resolve a claim much faster than under the current system, thereby allowing the attorney to collect legal fees much more quickly. By resolving claims faster, attorneys can handle more cases and generate more income and better server their clients, the claimants.

The invention can be used to handle any of a variety of insurance claims including personal injury claims, medical malpractice claims, workers compensation claims, asbestos claims, warranty claims, and property damage (auto, home, etc.) claims, for example. The invention can also be used to handle liability claims that arise out of accidents that occur on the premises of a corporation, or accidents involving the corporation's vehicles.

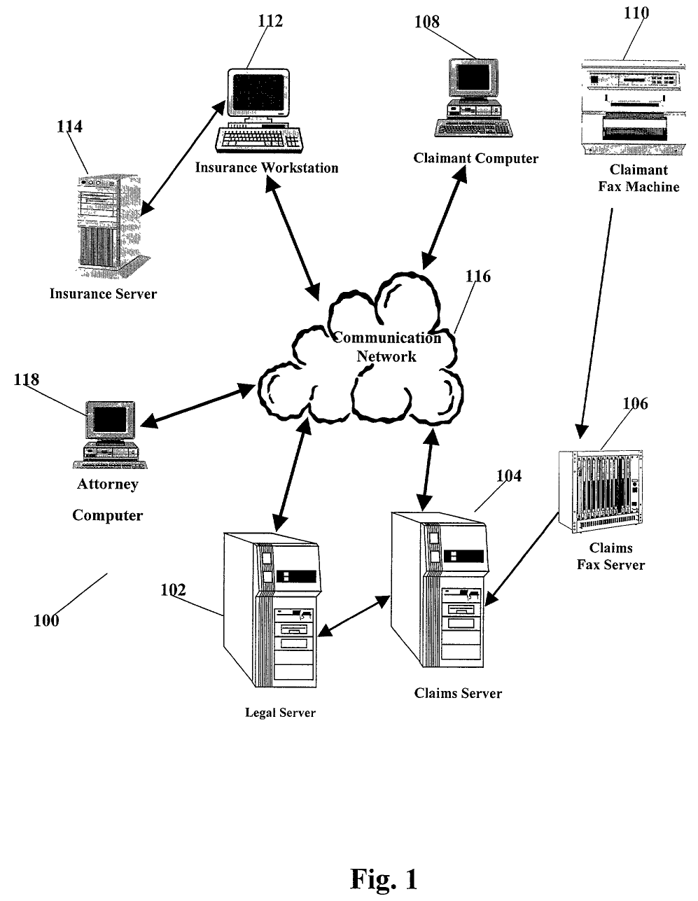

Referring to FIG. 1, one disclosed embodiment of a system 100 according to the invention includes a claims server 104, a claims fax server 106, a legal server 102, at least one attorney computer 118, at least one claimant computer 108, at least one claimant fax machine 110, at least one insurance carrier server (insurance server) 114, at least one insurance carrier workstation (insurance workstation) 112, and a communication network 116 (such as the Internet, for example), although not all of these components are necessarily required for the invention. For example, there might not be an attorney computer 118 involved. The attorney computer 118, the insurance computer 112, the claimant computer 108, the claim server 104, and the legal server 102 are in communication with the communication network 116. The claims server 104 and the legal server 102 can be the same server or separate servers, and can be built on Oracle 8i and the Oracle Application Server running on a Unix server, for example. The claimant fax machine 110 and the claims fax server 106 can communicate with each other via a telephone network (not shown). The claims fax server 106 is also in communication with the claims server 104.

An attorney using the attorney computer 118, an insurance agent using the insurance computer 112, or a claimant using the claimant computer 108 can establish communication with the claims sever 104 via the communication network 116 using, for example, a network browser (such as NETSCAPE NAVIGATOR, for example) that is resident on the particular user's (claimant, attorney, or insurance agent) computer. Additionally, the attorney using the attorney computer 118 or the claimant using the claimant computer 108 can establish communication with the legal server 102 in the same or similar manner as with the claim server 104.

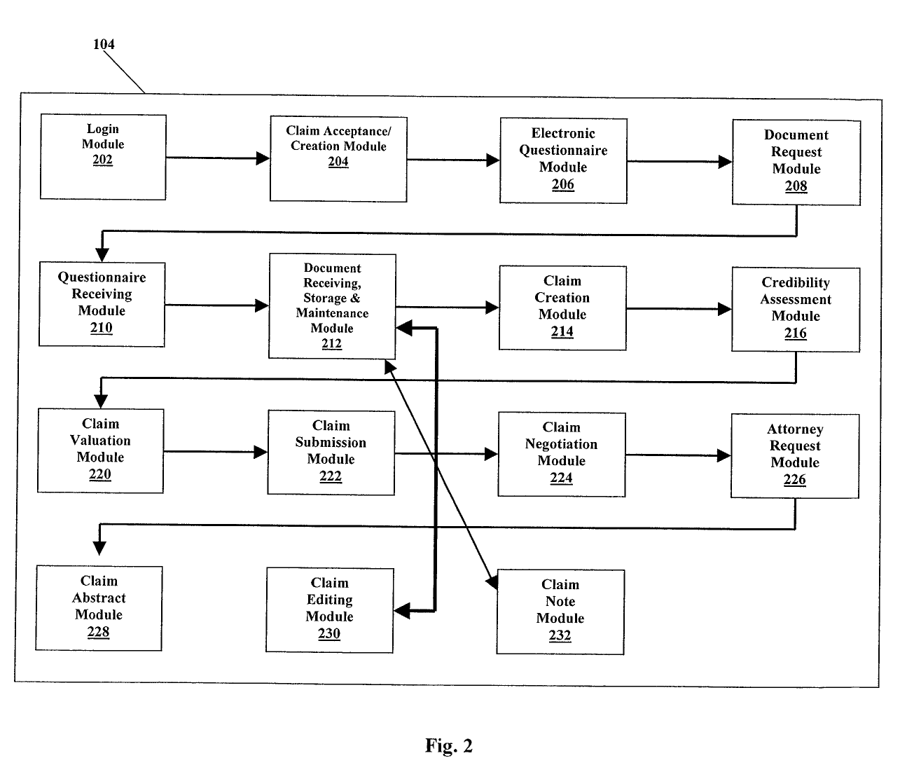

Referring to FIG. 2, the software that is used to process insurance claims (claims processing software) is resident on the claims server 104 and includes, in the disclosed embodiment, a login module 202, a claim acceptance/creation module 204, an electronic questionnaire module 206, a document request module 208, a questionnaire receiving module 210, a document receiving, storage, and maintenance module 212, an insurance claim creation module 214, an insurance claim credibility assessment module 216, an insurance claim valuation module 220, an insurance claim submission module 222, an insurance claim negotiation module 224, an attorney request module 226, an insurance claim abstract module 228, an insurance claim editing module 230, and an insurance claim note module 232.

In one embodiment of the invention, after an accident has occurred, a claim can be initiated by a claimant, an attorney for the claimant, an insurance carrier, or an insurance agent by connecting to the claim server 104 via the communication network 116 and creating a claim. If the claim is initiated by the insurance carrier or the insurance agent, the claimant is then notified by the insurance carrier or the insurance agent that a claim has been initiated on the claims server 104.

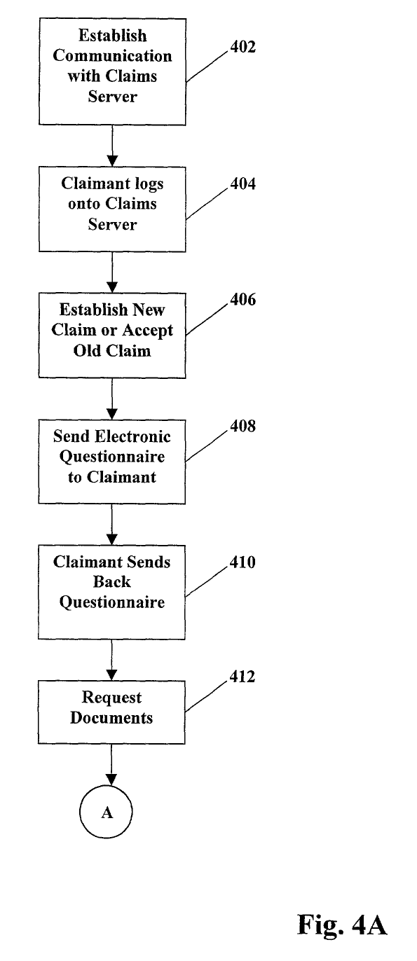

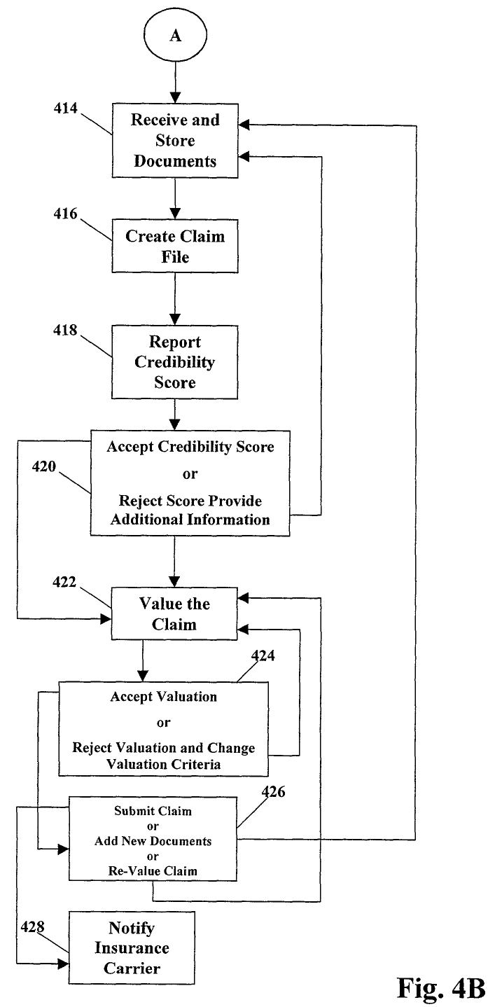

Referring to FIGS. 4A and 4B, after a claimant has been notified (by an insurance carrier or insurance agent, for example) that a claim has been initiated or after the claimant has decided to initiate a claim, the claimant, using the claimant computer 108, establishes communication with the claims server 104 via the communication network 115 using the network browser (step 402). Once the claimant establishes communication with the claims server 104, the login module 202 presents the claimant with a login display (step 404). After the claimant has logged onto the claims sever 104, the claim acceptance/creation module 204 presents the claimant with the option of establishing a new claim or accepting a claim that has been previously established by, for example, an insurance carrier or insurance agent (step 406). After the claimant establishes a new claim or accepts an existing claim, the electronic questionnaire module 206 sends the claimant an electronic questionnaire over the communication network 116 (step 408). The electronic questionnaire is displayed in the claimant's network browser window on the claimant computer 108. The electronic questionnaire is used to obtain information associated with the incident that caused the accident. The electronic questionnaire includes but is not limited to questions regarding the vehicles involved in the accident, the occupants of the vehicles, the scene of the accident, the weather conditions at the time of the accident, the existence of any witnesses, the damages that occurred, the injuries that occurred, the wages lost by the injured parties, and the various parties′ insurance information. After the claimant completes the electronic questionnaire, the claimant sends the electronic questionnaire back to the claims computer 104 over the communication network 116 (step 410). The questionnaire-receiving module 210 receives the electronic questionnaire from the claimant.

Based on the answers the claimant provides in the electronic questionnaire, the document request module 208 compiles a list of documents necessary to complete the insurance claim and requests that the claimant send them to claim server 104 (step 412). The claimant can mail the requested documents to someone associated with the claims server 104 or fax the requested documents using the claimant fax machine 110 or e-mail the documents (after they are converted to a digital format using a typical scanner). If the requested documents are mailed, the documents are scanned and digitally stored on the claims server 104. If the documents are faxed, the documents are received by the claims fax server 106 and then transmitted to and stored on the claims server 104. If the documents are e-mailed, the documents are sent directly to the claims server 104. Regardless of the manner in which the requested documents are sent, the requested documents are received, stored, and maintained by the document receiving, storage, and maintenance module 212 (step 414). Depending on the how the claimant responds to the electronic questionnaire, the requested documents can include, a police report, an accident report, witness affidavits, various medical documents, medical bills, lost wages affidavits, and miscellaneous receipts. As the requested documents are received by the document receiving, storage, and maintenance module 212, they are stored in the claimant's insurance claim file that is created by the insurance claim creation module 214 (step 416).

After the claim file is created, the insurance claim credibility assessment module 216 assesses the credibility of the claim based on the claimant's responses to the electronic questionnaire and the received documents and reports to the claimant a credibility score and any additional information required to increase the credibility score (step 418). The claimant is given the option of accepting the credibility score or rejecting the credibility score and providing any additional documentation or information needed to increase the credibility score (step 420). For example, if the claimant reported physical injuries in the electronic questionnaire and did not submit medical documentation to support the claim, the claim would receive a low credibility score. The claimant would then be given the option of accepting the low credibility score or rejecting the credibility score and supplying the necessary medical documentation. After the medical documentation is received by the claims server 104, the credibility score would be recalculated. The credibility assessment module 216 includes a fraud detection algorithm which is used to identify potentially suspect claims for closer scrutiny. The credibility assessment module 216 is also a tool to educate the claimant on how the insurance carrier may view the claim, how to improve the credibility of the claim, and inform the claimant of problems that may hinder their efforts to resolve the claim. The claimant may also edit the claim file by using the insurance claim-editing module 230. For example, the claimant may wish to change incorrect information (e.g. change of address) or add new information (e.g. additional medical expenses) to the claim file or otherwise modify the claim file.

After the claimant accepts the credibility score, the insurance claim valuation module 220 provides the claimant with the option of having the value of the claim determined by the valuation module 220 or choosing a particular value for the claim (step 422). The valuation module 220 includes tools to help the claimant determine a range of values of the claim using different valuation methods. Some of the valuation methods available include the insurance industry rule-of-thumb standard of three times special damages, links to reporters of anecdotal settlement amounts, industry statistics, and jury verdicts (the same tools that practicing trial lawyers use), and government reports of jury verdict and settlement trends.

If the claimant chooses to have the value of the claim determined by the valuation module 220, the valuation module 220 produces a valuation worksheet using some of the information from the documentation previously supplied by the claimant. The information used can include the claimant's cumulative monetary losses to date, and the claimant's projected future monetary losses such as expected future medical bills, for example. The claimant has the option of accepting the valuation or changing the valuation criteria and having the claim re-valued (step 424). For example, the claimant may wish to increase the projected future monetary losses or make corrections in the current cumulative monetary losses. The valuation module 220 allows the claimant to accurately determine the value of the insurance claim and thereby enables the claimant to negotiate knowledgeably with the insurance carrier.

After the claimant accepts the system-determined claim valuation or has chosen a particular value for the claim, the insurance claim submission module 222 provides the claimant with the option of submitting the claim to the insurance carrier, not submitting the claim and updating the documentation stored in the claim file, or not submitting the claim and instead re-valuing the claim (step 426). If the claim is submitted, the claim submission module 222 notifies the insurance carrier that a claim has been submitted (step 428). In comparison to the current method of filing an insurance claim, submitting the claim to the insurance carrier only after all relevant documents have been collected and the claim file is completed reduces the time and expense that the insurance carrier must invest to process the claim and generally results in a faster resolution of the claim.

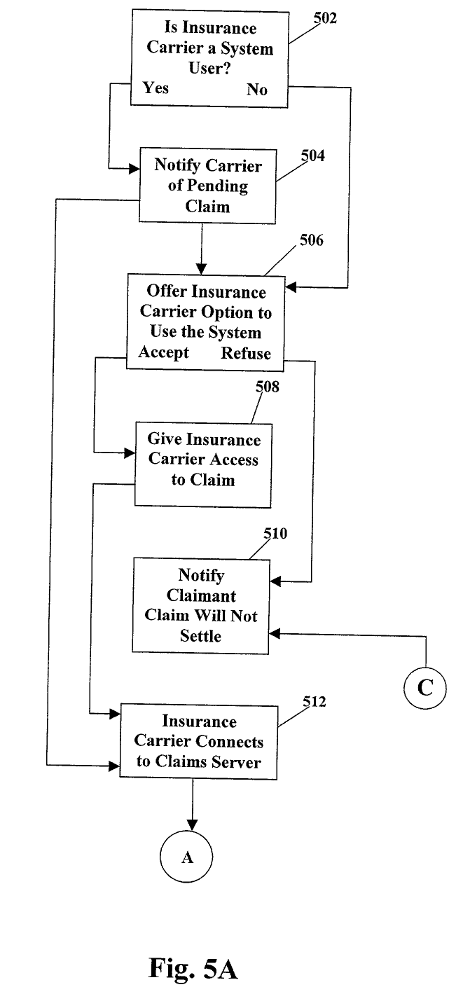

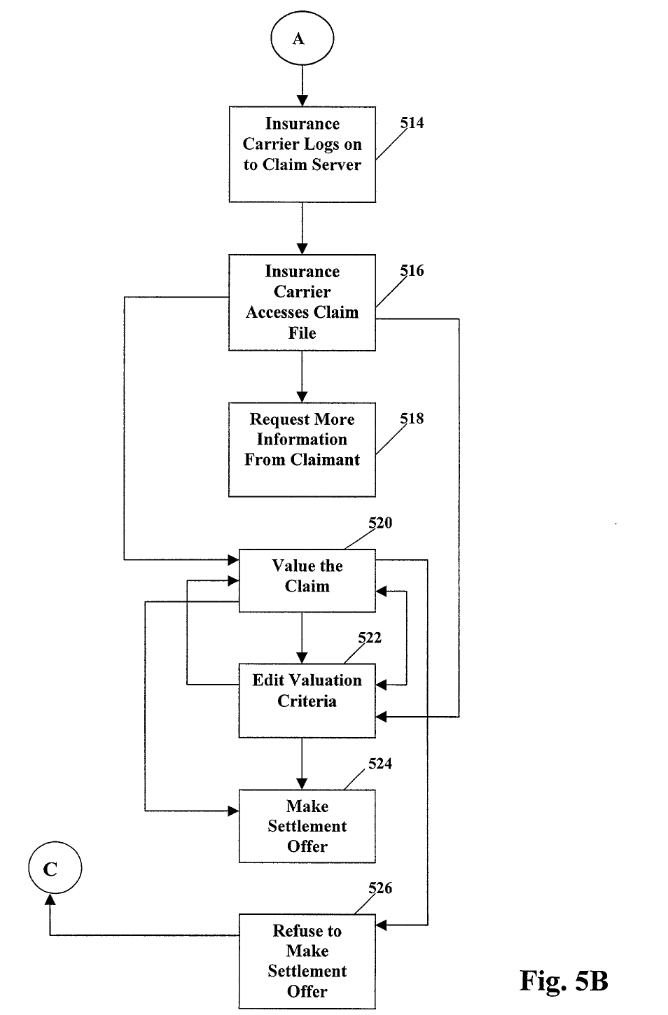

Referring to FIGS. 5A and 5B, in the case where the claim has been initiated by the claimant (as opposed to being initiated by, for example, an insurance carrier or agent), the claims server 104 determines if the insurance carrier that is associated with the accident (determined by information submitted by the claimant) is a user of the system 100 (step 502). If the insurance carrier is a user of the system 100, the insurance carrier is then notified (via e-mail, fax, or phone, for example) of the newly filed claim (step 504). If the insurance carrier is not a user of the system 100, an offer is made to the insurance carrier (via e-mail, fax, or phone, for example) to use the system 100 (step 506). If the insurance carrier agrees the use the system 100, the insurance carrier is given access to the claim (step 508). If the insurance carrier does not agree to use the system 100, the claimant is notified that a settlement will not be reached and the attorney request module 226 offers the claimant the option of referring the insurance claim to an attorney (step 510).

After the insurance carrier is notified of the claim and is either a user of the system 100 or agrees to become a user of the system 100, the insurance carrier, using the insurance carrier workstation 112, establishes communication with the claims server 104 via the communication network 116 using the network browser (step 512). Once the insurance carrier establishes communication with the claims server 104, the login module 202 presents the insurance carrier with a login display (step 514). After the insurance carrier has logged into the claims sever 104, the insurance carrier is free to access and review the insurance claim file (step 516). The insurance carrier has the option of requesting more information from the claimant and doing nothing further until the additional information is received (step 518). The insurance carrier also has the option of requesting that the valuation module 220 value the claim as previously described (step 520), or editing the valuation criteria and having the valuation module 220 re-value the claim (step 522). The insurance carrier can then make a settlement offer (step 524), or refuse to make a settlement offer (step 526). If the insurance carrier makes a settlement offer, the claim negotiation module 224 sends the settlement offer to the claimant. If the insurance carrier refuses to make a settlement offer, the claim negotiation module 224 informs the claimant that a settlement will not be reached and the attorney request module 226 offers the claimant the option of referring the claim to an attorney (step 510).

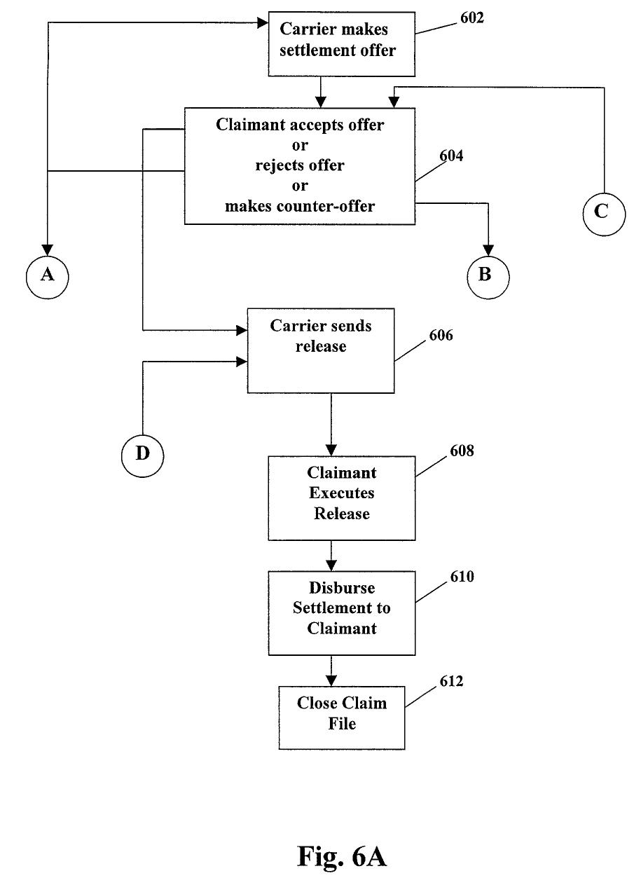

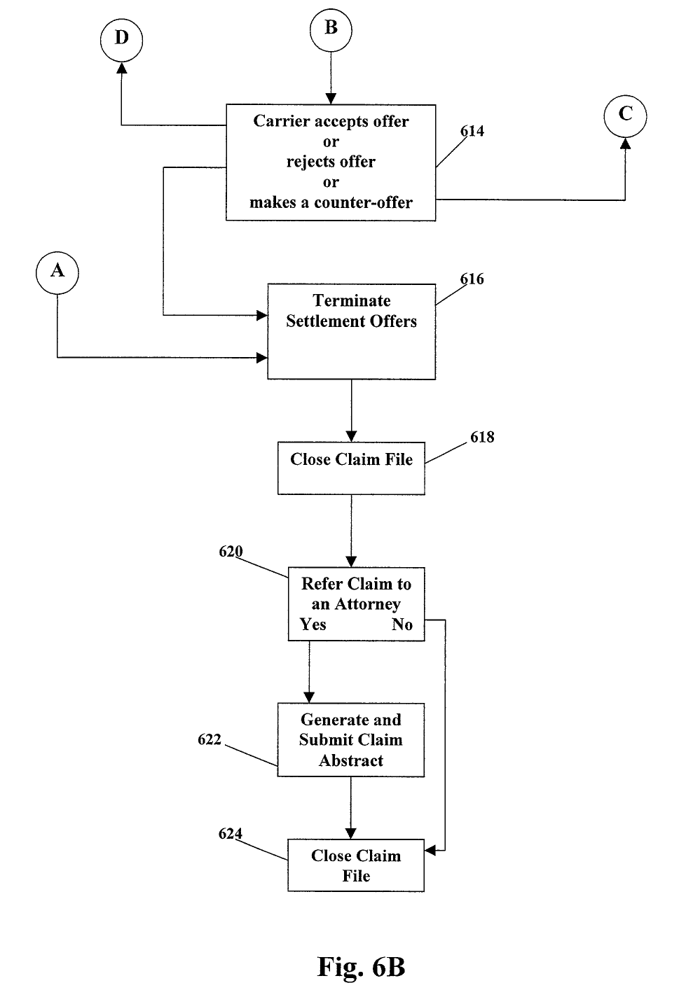

Referring to FIGS. 6A and 6B, after the carrier makes a settlement offer (step 602), the claimant has the option accepting the offer, rejecting the offer, or making a counter-offer (step 604). If the claimant accepts the carrier's offer, the carrier sends a release form to the claimant (step 606) via e-mail or as an HTML file through the network browser. The claimant prints out the release form, signs it, and then mails it to someone associated with the claims server 104 (step 608). The release is held in escrow until the claim settlement payment is received.

After the insurance carrier is notified that the release has been executed, the insurance carrier submits the settlement payment to the claims server 104 which, in turn, after deducting fees for providing the service, disburses the settlement payment to the claimant and sends the executed release to the insurance carrier (step 610). After payment is received from the insurance carrier, the claim file is closed and the claimant and insurance carrier are notified (step 612).

If the claimant rejects the carrier's settlement offer, the carrier has the option of making another settlement offer (step 602) or terminating negotiations (step 616). The claimant also has the option of termination negotiations (step 616). If either the claimant or the carrier terminates negotiations (step 616), the claim file is closed (step 618). The attorney request module 226 then offers the claimant the option of having the claim referred to an attorney (step 620). If the claimant chooses to have the claim referred to an attorney, the insurance claim abstract module 228 generates an abstract of the insurance claim and submits the abstract to the legal server 102 (step 622) and informs the claimant that the abstract has been submitted and that the claim file is closed (step 624). If the claimant chooses not to have the claim file referred to an attorney, the file is closed (step 624).

If the claimant makes a counter-offer, the carrier has the option of accepting the counter-offer, rejecting the counter-offer, or making another counter-offer (step 614). If the carrier accepts the claimant's counter-offer, the carrier sends the claimant a release as previously described (step 606). If the carrier rejects the claimant's offer, the negotiations are terminated (step 616), the claim file is closed (step 618), and the claimant is given the option of having the claim auctioned to an attorney as previously described (step 620). If the carrier makes a counter-offer, the claimant has the option of accepting the offer, rejecting the offer, or making yet another counter-offer as previously described (step 604). In general, the negotiation process can continue indefinitely or for a predetermined amount of time (determined by the claimant, for example).

The claim processing software on the claims server 104 also includes an insurance claim note module 232. This module allows the claimant, the claimant's attorney, or the insurance carrier make private notes regarding the insurance claim. The notes are stored on the claims server 104. The notes are associated with the claim file but not stored in the claim file, and are accessible only by the creator of the note.

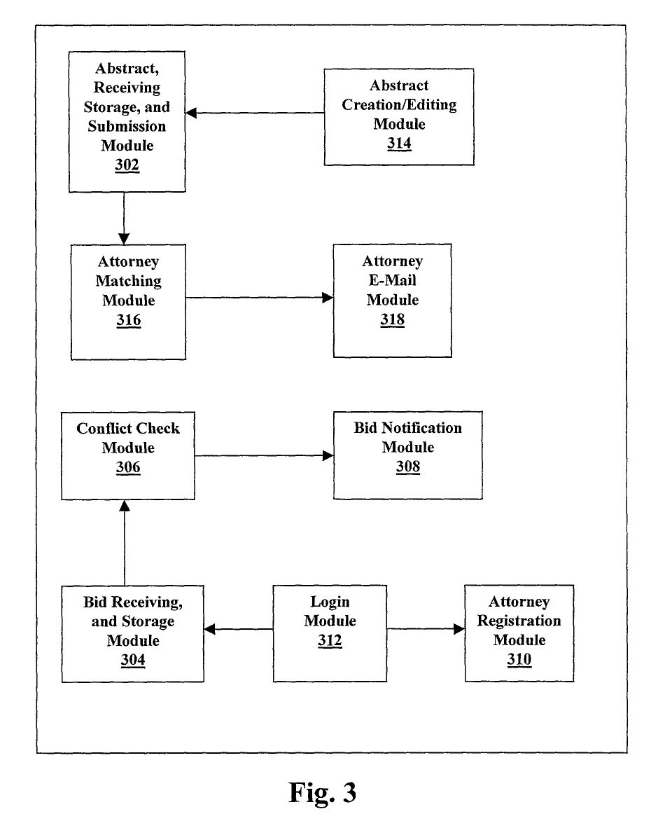

When the attorney request module 226 refers an unresolved insurance claim to an attorney, the insurance claim abstract module 228 generates an abstract of the insurance claim and submits the abstract along with the claim file to the legal server 102. The abstract and the insurance file are stored on the legal server 102 and made available to attorneys who use the system 100 through an auction process. Referring to FIG. 3, the software used to auction an insurance claim (auction software) is resident on the legal server 102 and includes an abstract receiving, storage, and submission module 302, a bid receiving and storage module 304, a conflict check module 306, a bid notification module 308, an attorney registration module 310, a login module 312, an abstract creation/editing module 314, an attorney matching module 316, and an attorney e-mail module 318.

An attorney that wishes to “bid” on unresolved insurance claims must be registered on the legal server 102. The attorney, using the attorney computer 118, establishes communication with the legal server 102 via the communication network 116 using the network browser. Once the attorney establishes communication with the legal server 102, the login module 312 presents the attorney with a login display. If the attorney has previously registered, the attorney can log onto the legal server 102 and participate in the claim auctioning process. If the attorney has not previously registered, the attorney registration module 310 prompts the attorney for registration information, confirms the attorney's identity, and approves the attorney's registration. Thereafter, the attorney is able to log onto the legal server 102 and participate in the claim auctioning process described below.

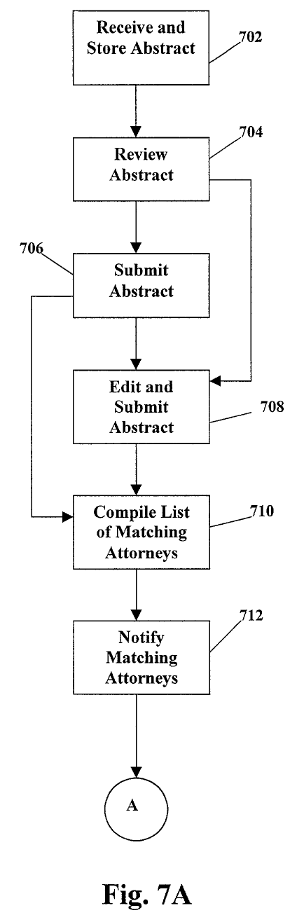

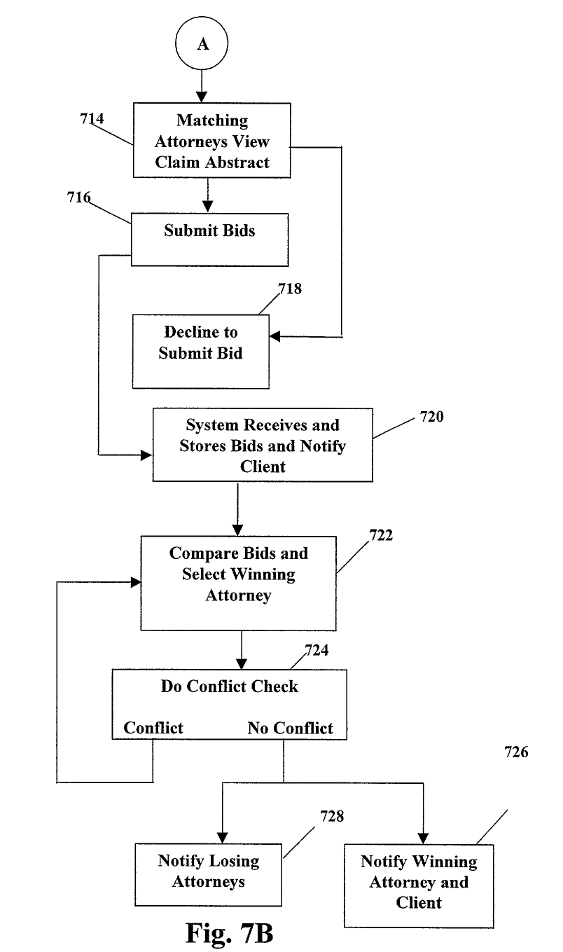

Referring to FIGS. 7A and 7B, after the insurance claim abstract module 228 submits the insurance claim abstract and the insurance claim file to the legal server 102, the receiving, storage, and submission module 302 receives and stores the claim abstract and the claim file on the legal server 102 (step 702). A claimant also has the option of using the abstract creation/editing module 314 to submit an abstract of a claim that was not handled by the claims server 104. The claimant creates an abstract by entering a brief description of the accident and any damages sustained, such as medical injuries, for example. The receiving, storage, and submission module 302 then stores the newly created claim abstract on the legal server 102.

After the claim abstract has been received and stored or newly created and stored, the claimant next reviews the claim abstract (step 704) and decides either to submit the claim abstract to a claim auction (step 706) or to edit the abstract (using the abstract creation/editing module 314) and then submit the abstract to the claim auction using the abstract receiving, storage, and submission module 302 (step 708). After the claim abstract has been submitted to the claim auction, the attorney-matching module 316 reviews the abstract and compiles a list of attorneys that could potentially handle the claim (step 710). The attorney-matching module 316 selects attorneys who are both registered to practice in the state in which the accident occurred and who are located in the county in which the accident occurred. The attorney e-mail module 318 then notifies each attorney on the list via e-mail that there is an unresolved insurance claim available for auction (step 712). Attorneys that are interested in the unresolved claim can review the claim abstract (step 714). After reviewing the claim abstract, interested attorneys can submit bids to handle the claim (step 716) or decline to submit a bid (step 718). As bids for a particular unresolved claim are submitted by interested attorneys, the bid-receiving and storage module 304 receives the bids and maintains a bid history and notifies the client that bids for the claim have been received and available for examination (step 720). A typical bid for an unresolved claim includes a copy of the bidding attorney's resume and the amount of the attorney's fee to handle the claim. Bids for the particular unresolved claim can be submitted by interested attorneys for a time period that is determined by the claimant. After the deadline for submitting bids has passed, the claimant reviews the submitted bids and selects an attorney to handle the claim (step 722). After the claimant has selected an attorney, the bid conflict check module 306 reviews the claim file and the attorney profile to determine if there is any reason why the selected attorney cannot handle the client's claim (step 724). If there is a conflict, the claimant is notified and instructed to select another attorney from the bid list. If there is no conflict, the bid notification module 308 notifies the winning attorney and the claimant and discloses both parties′ identities (step 726). Losing attorneys are notified that the particular unresolved claim has been won and that the claim is now closed (step 728). The winning attorney and the claimant are then free to contact each other.

Variations, modifications, and other implementations of what is described herein will occur to those of ordinary skill in the art without departing from the spirit and the scope of the invention. Accordingly, the invention is not to be defined solely by the preceding illustrative description.

What is claimed is:

1. A computer-based method of managing an insurance claim, comprising:
(A) sending over a network to a claimant a questionnaire about an incident;
(B) receiving over the network a response to the questionnaire;
(C) sending over the network to the claimant a request for at least one document associated with the incident, the request based on at least some of the received response to the questionnaire;
(D) receiving, storing, and maintaining the at least one document requested of the claimant;
(E) creating the insurance claim which includes the at least one document and the at least some of the response to the questionnaire; and
(F) assigning a credibility rating to the insurance claim based on the at least one document and at least some of the response to the questionnaire.

2. The method of claim 1 further comprising estimating a monetary value associated with the insurance claim.

3. The method of claim 1 further comprising submitting the insurance claim to an insurance company on behalf of the claimant.

4. The method of claim 1 further comprising negotiating terms of a claim settlement with the insurance company.

5. The method of claim 1 further comprising requesting an attorney to represent the claimant.

6. The method of claim 1 further comprising generating an abstract of the insurance claim.

7. The method of claim 1 further comprising editing the at least one document.

8. The method of claim 1 further comprising electronically generating and storing notes associated with the insurance claim.

9. The method of claim 1 wherein the network comprises the Internet.

10. A computer-based system for managing an insurance claim, comprising:
(A) an electronic questionnaire module for sending over a network to a claimant a questionnaire about an incident;
(B) a receiving module for receiving over the network a response to the questionnaire;
(C) a document request module for sending over the network to the claimant a request for at least one document associated with the incident, the request based on at least some of the received response to the questionnaire;
(D) a receiving, storage, and maintenance module for receiving, storing, and maintaining the at least one document requested of the claimant;
(E) an insurance claim creation module for creating the insurance claim which includes the at least one document and the at least some of the response to the questionnaire; and
(F) an insurance claim credibility assessment module for assigning a credibility rating to the insurance claim based on the at least one document and at least some of the response to the questionnaire.

11. The system of claim 10 further comprising an insurance claim valuation module for estimating a monetary value associated with the insurance claim.

12. The system of claim 10 further comprising an insurance claim submission module for submitting the insurance claim to an insurance company on behalf of the claimant.

13. The system of claim 10 further comprising an insurance claim negotiation module for negotiating terms of a claim settlement with the insurance company.

14. The system of claim 10 further comprising an attorney request module for requesting an attorney.

15. The system of claim 10 further comprising a claim abstract module for generating an abstract of the at least one insurance claim.

16. The system of claim 10 further comprising an editing module for editing the at least one document.

17. The system of claim 10 further comprising a note module for electronically generating and storing notes associated with the insurance claim.

18. The system of claim 10 wherein the network comprises the Internet.

19. A method of evaluating the credibility of an insurance claim, comprising:
(A) sending over a network to a claimant a questionnaire about an incident;
(B) receiving over the network a response to the questionnaire;
(C) sending over the network to the claimant a request for at least one document associated the incident, the request based on at least some of the received response to the questionnaire; and
(D) determining a credibility score based on the at least one document and the at least some of the received response to the questionnaire.

20. The method of claim 19 further comprising reporting over the network to the claimant the credibility score and how the credibility score was calculated.

21. The method of claim 20 further comprising informing the claimant over the network about any documents not yet received that affect the calculation of the credibility score.
